(19) United States
(12) Patent Application Publication
(10) Pub. No.: US 2008/0065716 A1
(43) Pub. Date: Mar. 13, 2008

(54) Systems and methods for controlling test instruments with a computer

(76) Inventors: Thomas M. Wright, Santa Rosa, CA (US); Kristopher L. Hett, Windsor, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/480,670

(22) Filed: Jun. 30, 2006

(51) Int. Cl. G06F 17/00; G06F 15/16; G06F 9/00

(52) U.S. Cl. 709/203; 700/90

(57) ABSTRACT

A system and method for acquiring test measurement data using a workstation and a test instrument. The workstation may include a workstation application generated from a test instrument software system and a workstation communications interface. The test instrument may include a test measurement application generated from the same test instrument software system and a test instrument communications interface. A communications medium may be used to connect the workstation communications interface and the test instrument communications interface to enable a user to control the test instrument using the workstation application.

### BACKGROUND OF THE INVENTION

1. Field of the Invention

The present invention relates to test and measurement systems, and more particularly to systems and methods for using a computer to control test instruments.

2. Description of Related Art

Test instruments are sometimes connected to general-purpose workstations, such as personal computers (PC) to allow a user to control the test instrument. The workstation provides the user with several advantages. One advantage is that it allows a user to operate a test instrument from a location other than the location of the test instrument. Another advantage stems from the increased data processing power typically found on a general-purpose workstation. Test instruments typically include resources for controlling the hardware that collects test data, but lack the memory resources, computing power and programming resources for analyzing the data collected.

This setup between a test instrument and a workstation may be implemented in many scenarios, such as:
(1) Single test instrument-to-single local workstation: a relatively simple, dedicated, and short distance communications link between the workstation and the test instrument. This link typically uses hardware and software protocols that may include: standard commands for programmable instruments (SCPI), the general programmable instrument bus (GPIB) or IEEE 488.2, USB, and others that implement communication between two different devices that are near each other.
(2) Single test instrument-to-remote workstations: typically employs communications over a local area network (LAN) or over the Internet. This scenario allows a user to obtain data from a test instrument without having to be at the test instrument location. The distance may be any distance supported by the protocols, from as close as a different room to as far as another country.
(3) Many test instruments-to-many remote workstations: May use the same infrastructure as the single test instrument-to-remote workstations, but includes the ability to communicate between multiple instruments and multiple workstations.

Instrument-to-workstation systems function via software applications in the test instrument and software applications in the workstation. These software applications make test instrument functions available to the user, whether it be at the test instrument or at the workstation. The test instrument software applications are integrated with the hardware of the test instrument allowing a user to directly interface with the instrument. The workstation software applications function remotely and include software that communicates commands configured to effect test instrument functionality available directly to the user at the test instrument.

There are several problems with current implementations of instrument/workstation systems. First, separate and distinct software applications are used in the test instrument and in the workstation. This increases development efforts by requiring development of applications on both the test instrument and the workstation. It increases training requirements by multiplying the number of software applications for a user to learn. Current implementations may also complicate data transport by adding overhead to the communications link. In some implementations, the workstation software application must itself be transported over a network or other communications link.

There is a need for improvements in systems and methods for providing test instrument to workstation functionality.

### SUMMARY

In view of the above, systems and methods consistent with the present invention may include a workstation and a test instrument. The workstation may include a workstation application generated from a test instrument software system and a workstation communications interface. The test instrument may include a test measurement application generated from the same test instrument software system and a test instrument communications interface. A communications medium may be used to connect the workstation communications interface and the test instrument communications interface to enable a user to control the test instrument using the workstation application.

Various advantages, aspects and novel features of the present invention, as well as details of an illustrated example thereof, will be more fully understood from the following description and drawings.

Other systems, methods and features of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. In the figures, like reference numerals designate corresponding parts throughout the different views.

FIG. 1 is a schematic diagram of an example of an instrument-to-workstation system.

FIG. 2 is a block diagram of an example of an instrument-to-workstation system.

FIG. 3 is a diagram illustrating operation of an example of an instrument-to-workstation system.

FIG. 4 is a diagram illustrating operation of another example of an instrument-to-workstation system.

FIGS. 5A and 5B are listings of pseudo-code illustrating operation of a remote application enabler.

### DETAILED DESCRIPTION

In the following description of embodiments, reference is made to the accompanying drawings that form a part hereof, and which show, by way of illustration, specific embodiments in which the invention may be practiced. Other embodiments may be utilized and structural changes may be made without departing from the scope of the present invention.

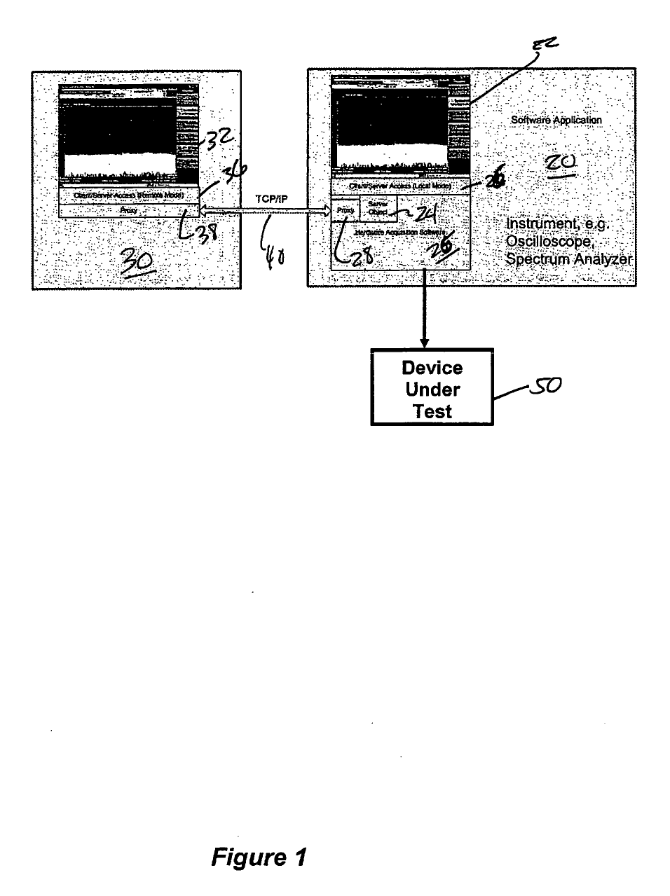

FIG. 1 is a schematic diagram of an example of an instrument-to-workstation system 10. The system 10 may include a test instrument 20 connected to a workstation 30 via a local area network (LAN) 40. The test instrument 20 may include a software application 22, hardware acquisition software 26, and a remote access enabler 26. The test instrument 20 may also may include a network communications interface to allow the test instrument 20 to communicate over the LAN 40.

The workstation 30 may include a software application 32, which is actually the same as the software application 22 in the test instrument as described below, and a remote access requester 36. The workstation 30 also may have a network communications interface to communicate over the LAN 40.

In the test instrument 20, the hardware acquisition software 26 may include hardware drivers that control hardware used to retrieve data signals from a device-under-test (DUT) 50. The type of hardware used to retrieve the data signals may depend on many factors, such as, the nature of the DUT 50, the type of signal being measured, and the type of measurements being made. The DUT 50 may be any device that may transmit, receive, or otherwise conduct a signal. Such devices may include a signal transmitter, a signal receiver, a signal transport medium (wireless or wired), a backplane, a bus system, a signal generator, or any other type of signal conducting device. The type of signals being measured may include radio frequency signals, bit streams, modulated or un-modulated signals, DC signals, AC signals, sinusoids, etc. Those of ordinary skill in the art will appreciate that any acquisition hardware and software may be used in example implementations of an instrument to workstation system.

The test instrument software application 22 may include software that performs test and measurement functions and provides a graphical-user interface (GUI). The software that performs test and measurement functions may include processes that operate on raw data collected by the acquisition hardware and software. The functions may range from higher level functions, such as fast Fourier transform (FFT), demodulation, swept spectrum measurements, spectrum analysis, bit error rate analyzers, protocol analyzers, etc. to lower level functions, such as, selecting inputs, setting modes, setting amplitude ranges, controlling a signal generator, scaling the signal display, selecting a timing scale, etc. The GUI portion of the test instrument software application 22 may include display software that operates with the functional software to provide a signal display, or software that allows a user to enter commands, or select measurement functions. To an extent, the GUI features available to the user depend on the capability and functionality of the test instrument 20. The test instrument 20 may be as simple as a digital voltmeter, or as sophisticated as a protocol analyzer. The software application 22 may include software that provides the test instrument 10 with functionality as a test and measurement instrument and a GUI. Advantageously, the test instrument software application 22 and the workstation software application 32 are generated from the same test instrument software system.

The LAN 40 may be any suitable network; however one of ordinary skill in the art will appreciate that any type of physical connection supported by the test instrument 20 and the workstation 30 may be used instead. Examples of physical connections that may be used in place of the LAN 40 include a serial connection, a parallel connection, a wireless connection, or other alternatives. The connection may implement USB, RS232, Bluetooth, or other alternatives.

The software application 22 performs the test instrument functionality in conjunction with the acquisition hardware via a hardware interface, which may include software that provides the software application 22 with access to the hardware acquisition software 26. In one example, the test instrument software application 22 is generated from source code prepared according to any programming language. In some examples, the source code may be generated using an object oriented programming language such as c++ or c-Sharp. Accordingly, components of the test instrument software application 22 or the workstation software application 32 may be instances of a class defined by object-oriented source code and instantiated for more specific applications at run time.

The source code used to generate the test instrument software application 22 is the same source code used to generate the workstation software application 32. The source code for the test instrument software application 22 is compiled and may be generated for implementation as an embedded system in the test instrument. The source code for the workstation software application 32 is compiled and generated for a general purpose workstation operating system, such as Windows™, Mac OS™, UNIX, and Linux, or other alternatives. The source code for the software applications 22, 32 may be written in any suitable programming language. Examples described below make reference to object-oriented programming languages, but those of ordinary skill in the art will appreciate that reference to any specific programming language, software development system or programming environment is not intended to limit the scope of the invention in any way.

The system 10 in FIG. 1 may further include an applications communications enabling system to provide the workstation 30 software application 32 with access to the acquisition hardware and software in the test instrument 20. The applications communication enabling system may include a remote applications enabler 36 operating in the workstation 30 and a local applications enabler 26 operating in the test instrument 20. The remote applications enabler 36 instantiates a remote proxy 38 to communicate with a local proxy 28 instantiated by a local enabling object 24, which is instantiated by the local applications enabler 26. The applications enabling system provides the workstation software application 32 with access to the test instrument acquisition software and hardware 25.

The system 10 in FIG. 1 may advantageously implement the same software application 22, 32 in both the test instrument 20 and the workstation 30 thereby eliminating the need to write different software for the workstation 30. In addition, both the test instrument 20 and the workstation 30 may present the user with the same GUI 24, 34 and the same functional capability reducing the amount of training required on using the system as well as the eliminating the need to duplicate functionality on different platforms. In addition, during operation, the workstation 30 performs as though the test instrument acquisition hardware was local even though a communication link separates the two. There is no need for software that configures commands to be transported between the workstation 30 and the test instrument 20. Accordingly, only the raw data acquired by the test instrument 20 is transported between the test instrument 20 and the workstation 30.

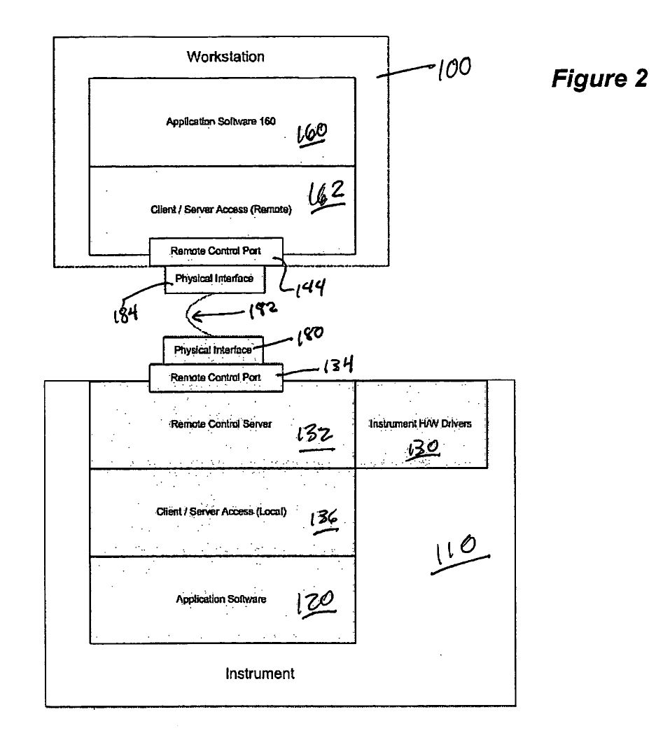

FIG. 2 is a block diagram of an example of an instrument-to-workstation system. The system in FIG. 2 may include a workstation 100 and a test instrument 110 connected by a physical connection 182. The workstation 100 may include a software application 160, a client/server access (Remote) layer 162, a remote control port 144, and a network hardware interface 184. The test instrument 110 in FIG. 2 may include a software application 120, a client/server access (Local) layer 136, a remote control server 132, an instrument hardware driver 130, a remote control port 134, and a network hardware interface 180. In one example of the system in FIG. 2, the client/server access (Remote) layer 162 and the workstation remote controller port 144 in the workstation 100, and the a client/server access (Local) layer 136, the remote control server 132 and the instrument remote controller port 134 are software components of an applications communication enabling system that provide the workstation 100 applications software 160 with access to the hardware on the test instrument 110. In one (more specific) example, the applications communication enabling system is implemented using the .NET Remoting system from Microsoft™.

The .NET Remoting system may include a library of functions accessible by function calls made from the identical source code for the workstation and test instrument application software 120, 160. The workstation and test instrument application software 120, 160, which are generated from the same source code, each include the same functions for accessing the remote control server 132 in the test instrument 110. The functions are represented by the client/server access (Remote) and the client/server access (Local) layers 162, 136, which are included in the source code for the applications software 120, 160. The client/server access (Remote) and the client/server access (Local) layers 162, 136 link to a library of functions when each system is generated during development. The functions invoked by the client/server access (Remote) 162 generate instances of clients to access the remote control server 132 remotely. The functions invoked by the client/server access (Local) 136 access the remote control server 132 locally using direct memory access and not TCP/IP.

Those of ordinary skill in the art will appreciate that alternatives to .NET Remoting may be used to the extent such alternatives provide access enabling features that would allow identical source code to be used for application software in both the workstation 100 and the test instrument 110. For example, JAVA™ may also be used to implement these access enabling components. Other systems that may be used in place of .NET Remoting or JAVA™ include proprietary systems or any other similar systems that may be accessed by an application through a program interface.

The .NET Remoting system is used herein as an enabler for application communication. It is a generic system for different applications to use to communicate with one another. .NET objects are exposed to remote processes, thus allowing interprocess communication. The applications can be located on the same computer, different computers on the same network, or even computers across separate networks. In the system in FIG. 2, the client/server access (Remote) 162, and the remote controller port 144 on the workstation 100 are .NET objects that access processes operating on the test instrument 110, such as instrument hardware drivers 130 as though they were on the same hardware platform. The client/server access (Local) 136, remote controller port 134 and the remote control server 132 on the test instrument 110 are .NET Remoting objects that operate with the .NET Remoting objects on the workstation 100 to provide the access to the processes running on the test instrument 110.

In an example of the .NET Remoting objects in FIG. 2, the client/server access (Remote) 162 creates the remote controller port 144 in the workstation 100 as an instance of a .NET Remoting port (or channel). The client/server access (Local) 132 creates the remote controller port 134 on the instrument 110 as an instance of a .NET Remoting port (or channel). The .NET Remoting ports may include network settings that allow for network communication between the workstation 100 and test instrument 110. For example, the .NET Remoting ports include knowledge of IP addresses of the workstation 100 and test instrument 110 and protocols used to effect communication between the devices.

The example system shown in FIG. 2 implements communication over a LAN although the workstation 100 and test instrument 110 may be on different LANs connected by the Internet. Versions of .NET Remoting that operate on non-network connections, such as USB or RS232, may not be available.

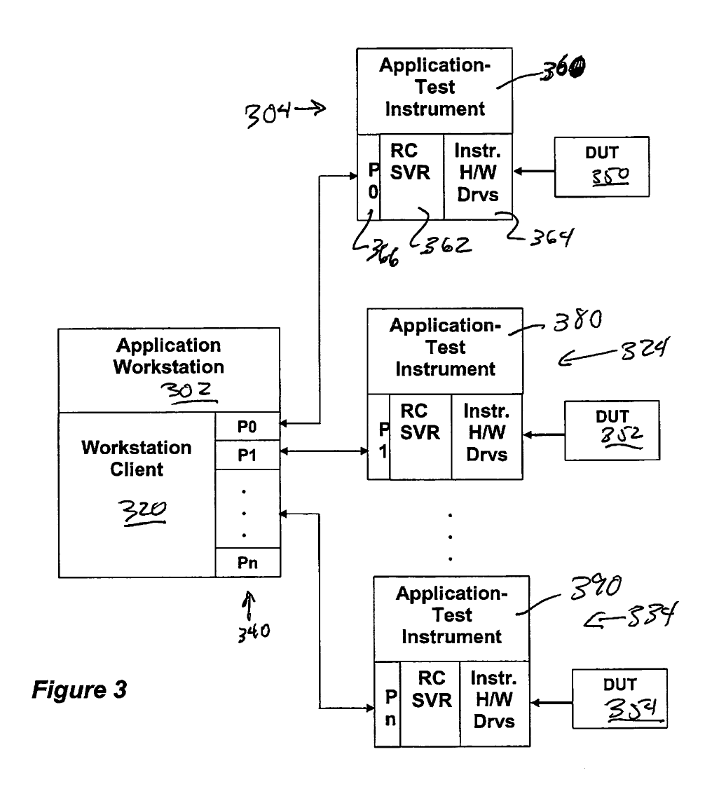

FIG. 3 is a diagram illustrating operation of an example of an instrument-to-workstation system. The system in FIG. 3 illustrates a workstation 302 connected to n test instruments 304, 324, 334. The workstation 302 and the n test instruments 304, 324, 334 each include an application software layer 310, 360, 380, 390, respectively, that are generated from the same source code. The workstation 302 also includes a workstation remote access client 320 and a set of remote control ports (P0-Pn) 340 corresponding to each test instrument 304, 324, 334. The first test instrument 304 includes the application layer 360, a remote control server 362, an instrument driver layer 364 and a remote control port 366. The first test instrument 304 is connected to a DUT 350. The system in FIG. 3 may be advantageously used to collect data from measurements of the DUT 350 at the workstation 302 employing a user interface and software functions that are the same as the user interface and software functions on the test instrument 304. The workstation 302 may simultaneously generate multiple instances of the application 310 to obtain data representing measurements taken from other DUTs 352, 354 via test instruments 360 and 380.

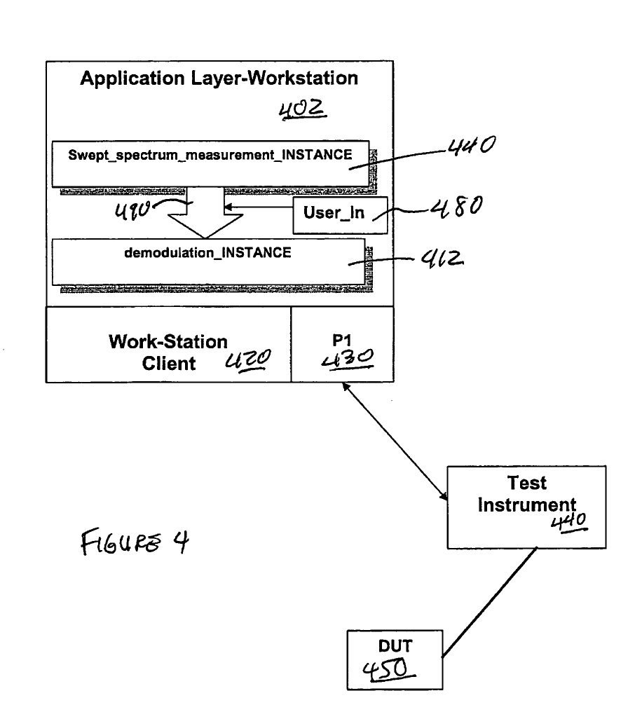

FIG. 4 is a diagram illustrating operation of another example of an instrument-to-workstation system 400. The system 400 in FIG. 4 shows how a user at a workstation 402 may switch to different types of measurements of the same DUT 450 quickly and efficiently. A user input 480 may effect a transition 490 from one instance used for taking one type of measurement to another instance for a different type of measurement. The workstation 402 in FIG. 4 shows the user input 480 switching from an instance for taking swept spectrum measurements 410 to an instance for performing demodulation 412 of a radio frequency signal being generated by a DUT 450 connected to remote test instrument 440.

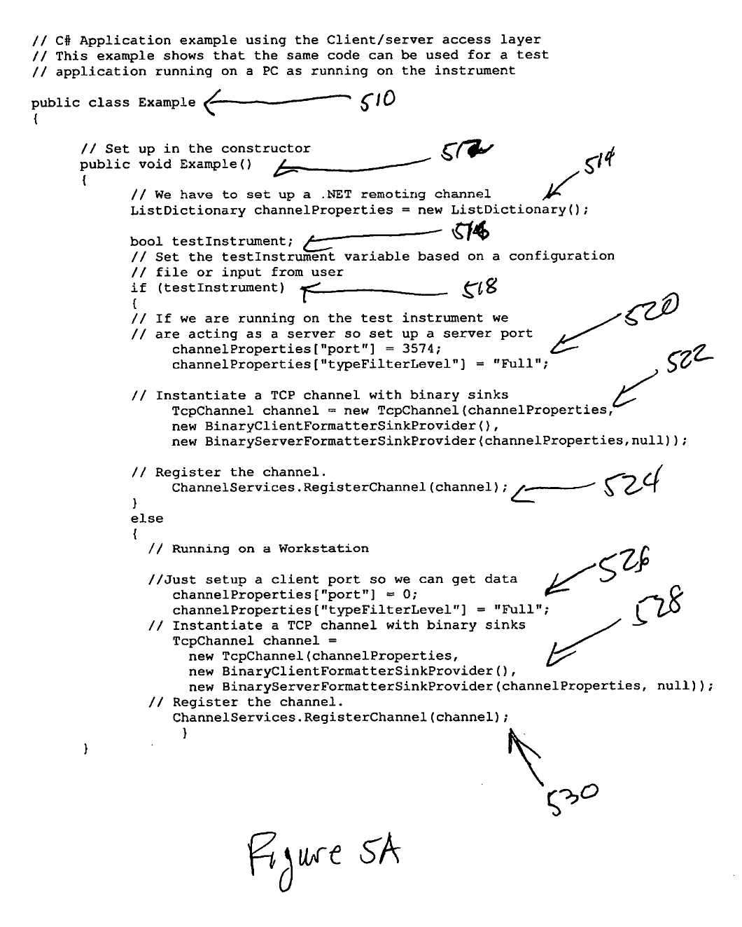

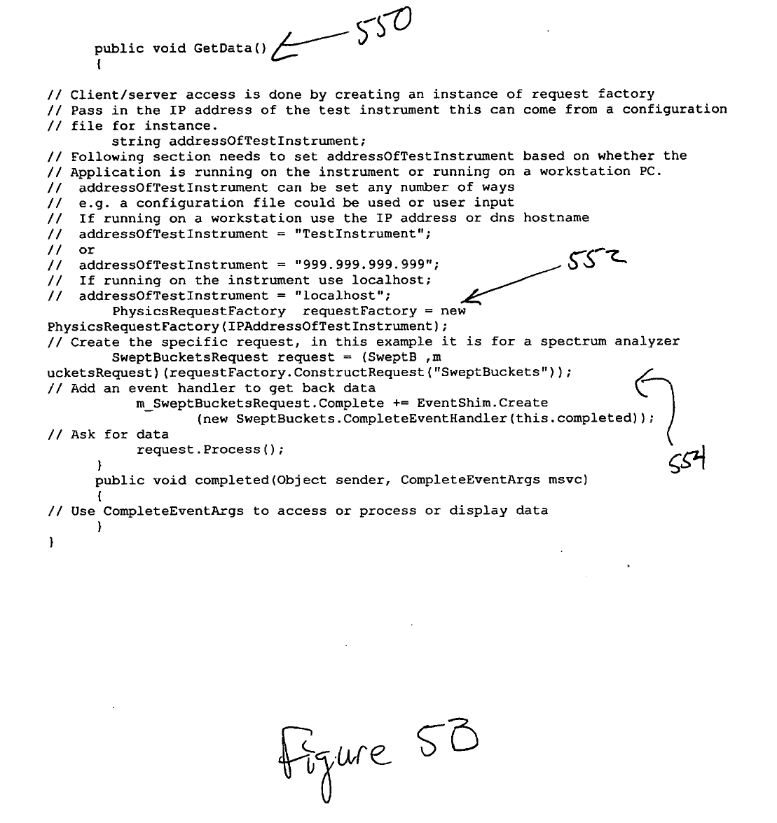

FIGS. 5A and 5B are listings of pseudo-code illustrating operation of a remote application enabler. The pseudo-code in FIGS. 5A and 5B is for an implementation written in C#. The implementation uses .NET Remoting for performing remote application enabling. The pseudo-code beings with a definition of a class called “Example” at 510. The class includes a method, Example( ), defined at 512, which sets up the .NET Remoting objects used to effect remote application enabling. The Example( ) method sets up a .NET Remoting channel at 514 and defines a flag called testInstrument at 516. The testInstrument flag is set using a configuration file or user input. The Example( ) method tests the flag to determine if it is running on the instrument of the workstation at 518. If it is running on a test instrument, it sets up a server port at 520. The Example( ) method then instantiates a TCP channel at 522 and registers the channel at 524. If the Example( ) method is running on a workstation, the Example( ) method sets up a client at 526 and a TCP channel at 528. The Example( ) method registers the channel at 530.

FIG. 5B includes pseudo-code that illustrates operation of the client/server ports setup in the Example( ) method. In FIG. 5B, a method, GetData( ), is defined at 550. The GetData( ) method creates an instance of an object that includes a request for data from the acquisition hardware on the test instrument. In this example, the object is called “requestFactory” and an instance called “PhysicsRequestFactory” is created at 552. An address for the data is then selected depending on whether the GetData( ) method is running on the workstation or the test instrument. If it is on the test instrument, a configuration file or user input may set an address of the test instrument to a local host indicator. If it is on the workstation, the address of the test instrument may be the test instrument's IP address, or DNS hostname. In the PhysicsRequestFactory instance, a specific request for data is made at 554. The example shown in FIG. 5B is a request for data for a spectrum analyzer. The PhysicsRequestFactory instance uses the address of the test instrument as a method parameter. The specific request for data is then made at 556.

The foregoing description of implementations has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

What is claimed:

1. A system comprising:
a workstation having a workstation application generated from a test instrument software system and a workstation communications interface;
a test instrument having a test measurement application generated from the same test instrument software system and a test instrument communications interface; and
a communications medium to connect the workstation communications interface and the test instrument communications interface to enable a user to control the test instrument using the workstation application.

2. The system of claim 1 wherein the test instrument software system includes a remote access enabling system.

3. The system of claim 2 wherein the remote access enabling system comprises:
a remote access enabler to operate in the test instrument application;
and
a remote access requestor to operate in the workstation application.

4. The system of claim 3 where:
the remote access enabler includes a server in a client/server access function; and
the remote access requester includes a client in the client/server access function.

5. The system of claim 4 where:
the server opens a first remote controller port on the test instrument for communicating with the workstation; and
the client opens a second remote controller port on the workstation for communicating with the test instrument.

6. The system of claim 1 where the test instrument software system includes source code used to generate application software in both the test instrument and the workstation.

7. The system of claim 2 where the remote access enabling system is implemented using either .NET Remoting or Java.

8. A test instrument comprising:
a test measurement application generated from a test instrument software system that may be used to generate a workstation application; and
a test instrument communications interface to connect to a workstation having the workstation application.

9. The test instrument of claim 8 where test instrument software system comprises:
a remote access enabler to operate in the test instrument application; and
a remote access requester to operate in the workstation application.

10. The test instrument of claim 9 where:
the remote access enabler includes a server in a client/server access function; and
the remote access requester includes a client in the client/server access function.

11. The test instrument of claim 10 where:
the server opens a first remote controller port on the test instrument for communicating with the workstation; and
the client opens a second remote controller port on the workstation for communicating with the test instrument.

12. The test instrument of claim 8 where the test instrument software system includes source code used to generate application software in both the test instrument and the workstation.

13. The test instrument of claim 9 where the test instrument software system includes software implemented using either .NET Remoting or Java.

14. A workstation comprising:
a workstation application generated from a test instrument software system that may be used to generate a test instrument application; and
a workstation communications interface to connect to a test instrument having the test instrument application.

15. The workstation of claim 14 wherein the test instrument software system comprises:
a remote access enabler to operate in the test instrument application; and
a remote access requestor to operate in the workstation application.

16. The workstation of claim 15 where:
the remote access enabler includes a server in a client/server access function; and
the remote access requester includes a client in the client/server access function.

17. The workstation of claim 16 where:
the server opens a first remote controller port on the test instrument for communicating with the workstation; and
the client opens a second remote controller port on the workstation for communicating with the test instrument.

18. The test instrument of claim 14 where the test instrument software system includes source code used to generate application software in both the test instrument and the workstation.

19. The test instrument of claim 14 where the test instrument software system includes software implemented using either .NET Remoting or Java.
